(19) United States
(12) Patent Application Publication
(10) Pub. No.: US 2007/0300065 A1
(43) Pub. Date: Dec. 27, 2007

(54) Time stamp apparatus, time correcting method, and time correcting program

(75) Inventor: Ryota Akiyama, Suginami (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,183

(22) Filed: Aug. 23, 2007

Related U.S. Application Data
(63) Continuation of application No. PCT/JP05/03296, filed on Feb. 28, 2005.

(51) Int. Cl. H04L 9/00

(52) U.S. Cl. 713/168

(57) ABSTRACT

A time stamp apparatus that carries out e-signature including local time based on the local time output from an internal clock, includes a radio wave time acquiring unit that receives a radio wave including standard time so as to acquire the standard time as radio wave time, an authentication time acquiring unit that acquires authentication time from a time publishing apparatus for publishing the authentication time synchronous with the standard time, and a time correcting unit that corrects the local time using the authentication time based on a difference between the radio wave time and the local time.

This is a continuation filed under 35 U.S.C. § 111(a), of International Application No. PCT/JP2005/003296, filed Feb. 28, 2005.

### BACKGROUND OF THE INVENTION

1. Field of the Invention

The present invention relates to a time stamp apparatus, a time correcting method and a time correcting program that carry out e-signature including local time based on the local time output by an internal clock.

2. Description of the Related Art

In recent years, as the electronic authentication technique develops, e-signature for authenticating creators and publishers of electronic documents has been used. The e-signature adopts techniques such as encryption keys, and such encryption keys maintain reliability of the e-signature. The e-signature includes national standard time (hereinafter, “standard time”), so that creation time and transmission time of electronic documents are tried to be authenticated.

Apparatuses that carry out e-signature including time are generally called time stamp apparatuses. The time stamp apparatuses have an internal clock, which counts local time and receives a radio wave including standard time to correct the local time so as to improve accuracy of the time to be used for e-signature.

When such e-signature including time is carried out, a difference between the local time of the time stamp apparatuses and the standard time should be suppressed to equal to or less than a predetermined value. That is to say, when the difference between the time included in the e-signature and the standard time can be warranted to be equal to or less than the predetermined value, the e-signature including the local time can authenticate the time related to an electronic document to be provided with the e-signature.

A method of suppressing the difference between the local time and the standard time to equal to or less than the predetermined value includes a similar method to a so-called wave clock and also a method of connecting to a standard time management server connected by a network so as to acquire the standard time from this server. For example, JP-A-2002-229869 discloses a method in which a server which manages standard time transmits standard time to a client apparatus capable of always communicating with this server and provides a warranty period to the transmitted standard time so as to detect fallibleness and an alteration of an internal clock in the client apparatus.

However, the above conventional time stamp apparatus cannot prevent the alteration of local time by an ill-intentioned user. For example, a radio wave including false standard time is used instead of a radio wave including true standard time, so that the local time of the time stamp apparatus can be deviated greatly from the true standard time. When such an alteration of the local time is made, the time related to an electric document cannot be authenticated.

Even if there is provided a structure in which the difference between the local time of the time stamp apparatus and the standard time included in the radio wave is monitored and when the difference exceeds a predetermined value, an alteration is determined, when a temperature attack by which the time stamp apparatus is heated or cooled and an radio wave attack by means of a false radio wave are used at the same time, such a structure does not function, thereby allowing the alteration of the local time.

In such a system where local time is compensated by using the radio wave time, the local time is altered by cooperated attacks of a false radio wave and temperature control. Therefore, when such a time compensating system is used in the time stamp apparatus, the time related to an electronic document to be e-signed cannot be warranted.

Since the time stamp apparatuses themselves can be miniaturized by miniaturization of various devices, the apparatuses are not always connected to networks such as LAN, and thus forms such as watches and mobile phones which are carried by users easily and are used as the need arises can be assumed, so that user's needs of such a use form is anticipated.

The technique disclosed in JP-A-2002-229869 relates to the client apparatus which is always connected to a network such as LAN to enable always-on communication with the standard time management server, but this technique cannot be applied to the time stamp apparatus of the above-mentioned use form.

As a result, a main object is to realize a time stamp apparatus that prevents alteration of time by an ill-intentioned user so as to heighten reliability of time to be used for e-signature and does not have to be always connected to a network.

### SUMMARY OF THE INVENTION

It is an object of the invention to at least partially solve the problems in the conventional technology.

According to one aspect of the invention, a time stamp apparatus that carries out e-signature including local time based on the local time output from an internal clock, includes a radio wave time acquiring unit that receives a radio wave including standard time so as to acquire the standard time as radio wave time, an authentication time acquiring unit that acquires authentication time from a time publishing apparatus for publishing the authentication time synchronous with the standard time, and a time correcting unit that corrects the local time using the authentication time based on a difference between the radio wave time and the local time.

According to another aspect of the invention, when an absolute value of a difference between standard time at the time of receiving local time with signature and the local time with signature is less than a fourth threshold, a time publishing apparatus returns authentication time at which the standard time is provided with signature and the local time with signature.

According to still another aspect of the invention, when an absolute value of a difference between standard time at the time of receiving local time with signature and the local time with signature is equal to or more than a fourth threshold, a time publishing apparatus stops return of authentication time to a client and returns warning information with signature to the client.

According to still another aspect of the invention, a time correcting method for correcting a difference between local time output from an internal clock and standard time, includes a radio wave time acquiring step of receiving a radio wave including standard time so as to acquire the standard time as radio wave time, an authentication time acquiring step of acquiring authentication time from a time publishing apparatus for publishing the authentication time synchronous with the standard time when an authentication key is presented, and a time correcting step of correcting the local time using the authentication time based on a difference between the radio wave time and the local time.

According to still another aspect of the invention, a computer program product for time correcting having a computer readable medium includes programmed instructions, for correcting a difference between local time output from an internal clock and standard time. The instructions, when executed by a computer, cause the computer to perform a radio wave time acquiring procedure of receiving a radio wave including standard time so as to acquire the standard time as radio wave time, an authentication time acquiring procedure of acquiring authentication time from a time publishing apparatus for publishing the authentication time synchronous with the standard time when an authentication key is presented, and a time correcting procedure of correcting the local time using the authentication time based on a difference between the radio wave time and the local time.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a summary of a time stamp apparatus according to an embodiment;

FIG. 2 is a diagram illustrating a summary of time correction;

FIG. 3A is a diagram illustrating a constitutional example 1 of the time stamp apparatus;

FIG. 3B is a diagram illustrating a constitutional example 2 of the time stamp apparatus;

FIG. 3C is a diagram illustrating a constitutional example 3 of the time stamp apparatus;

FIG. 4 is a functional block diagram illustrating a constitution of the time stamp apparatus;

FIG. 5 is a flowchart illustrating a processing procedure of an initial process where radio wave time is not acquired;

FIG. 6 is a flowchart illustrating a processing procedure of an initial process where radio wave time is acquired;

FIG. 7 is a flowchart illustrating a processing procedure of a time correcting process;

FIG. 8 is a diagram illustrating a summary of a delay compensating process for authentication time;

FIG. 9 is a flowchart illustrating a processing procedure for delay compensation in a time publishing server;

FIG. 10 is a flowchart illustrating a processing procedure for the delay compensation in the time stamp apparatus;

FIG. 11 is a diagram illustrating a computer executing a time correcting program;

FIG. 12 is a diagram illustrating a summary of a conventional time stamp apparatus;

FIG. 13 is a diagram illustrating an internal time alteration of the conventional time stamp apparatus; and

FIG. 14 is a diagram illustrating a drift due to a fraudulent act in the conventional time stamp apparatus.

### DETAILED DESCRIPTION OF THE PREFERRED EMBODIMENTS

A time stamp apparatus, a time correcting method and a time correcting program according to a exemplary embodiment of the invention will be described in detail below with reference to the accompanying drawings. The following embodiment describes when a time correcting process of the invention is applied to the time stamp apparatus. The invention is not limited to the embodiment.

### Embodiment

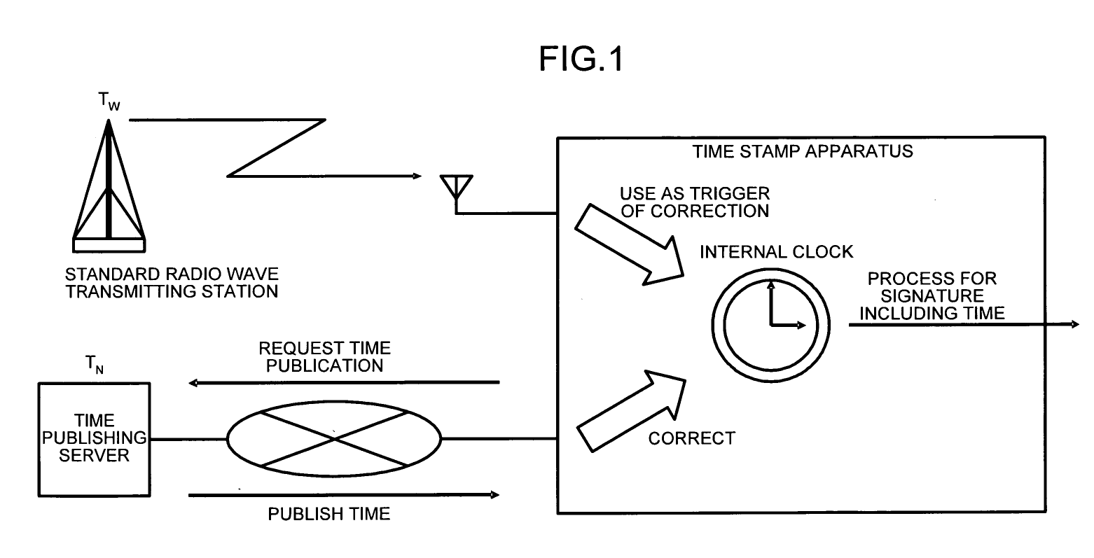

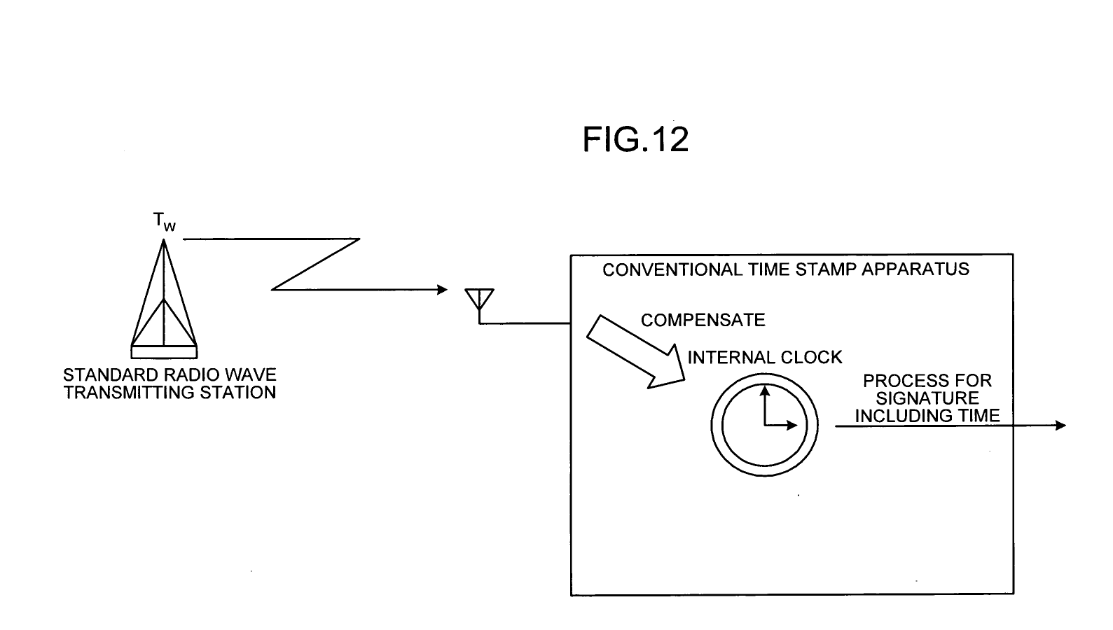

A time stamp apparatus to which a time correcting process as a characteristic part of this embodiment is applied will be described below with reference to FIGS. 1 to 3-3 and FIGS. 12 to 14. FIGS. 1 to 3-3 are diagrams relating to the time stamp apparatus of this embodiment, and FIGS. 12 to 14 are diagrams relating to a conventional time stamp apparatus.

First, a summary of the conventional time stamp apparatus will be described with reference to FIG. 12. FIG. 12 is a diagram illustrating the summary of the conventional time stamp apparatus. The time stamp apparatus is an apparatus that carries out e-signature including time on electronic data such as electronic documents. In recent years, electronic documents are generally sent or received via networks, and business that authenticates creation time and transmission time of the electronic documents (so-called “time business”) is achieving critical mass.

When e-signature is added to document data such as medical electronic documents including medical charts and death certificates and electronic documents of accountant and tax including sales checks and receipts as well as image data and video data by using the time stamp apparatus, created time and hour and transmitted date and hour of electronic data can be authenticated. Further, when the time stamp apparatus is incorporated into a digital camera or a digital video camera, the applicable scope of the time business can be extended also in fields requiring the recording of date and time.

When such a time business is structured, management of the time included in e-signature is very important. That is to say, not only is strictness of time sought but also the structure which does not allow alteration of the time by ill-intentioned users should be set up. For example, since ill-intentioned users, who alter time added to medical charts to cover up medical accidents or the date of patent inventions, are anticipated, it is necessary to prevent the alteration of time by these users.

As one form of the time business, the times of facilities and apparatuses publishing reliable times are synchronized with the times of many time stamp apparatuses receiving the time published by these facilities and apparatuses. The facilities and apparatuses which publish reliable times include standard wave transmitting stations and satellites which transmit radio waves including standard time, time publishing servers which are connected to internet and provide standard time according to presentation of authentication keys.

Companies which produce and sell the time stamp apparatuses to develop the time business should warrant that a difference between “time” of e-signature with time carried out by the sold time stamp apparatuses and standard time is equal to or less than a predetermined value. Such time warrant realizes the time business.

However, it is assumed that some people, who engage in the distribution of the time stamp apparatuses and purchase the time stamp apparatuses, are ill-intentioned users who alter the time of the time stamp apparatuses and carry out e-signature including false time. When such an alteration of time is allowed, the time cannot be warranted, and thus the time business is not realized.

The conventional time stamp apparatus shown in FIG. 12 has an internal clock therein, and the time counted by the internal clock is compensated by radio wave time (T_{W}) included in the standard radio wave to be transmitted from a standard radio wave transmitting station. The signature process including the time is executed by the compensated internal clock. This time stamp apparatus is provided with the function of a so-called “wave clock”, and the strictness of the time is maintained as long as well-intentioned users use the apparatus.

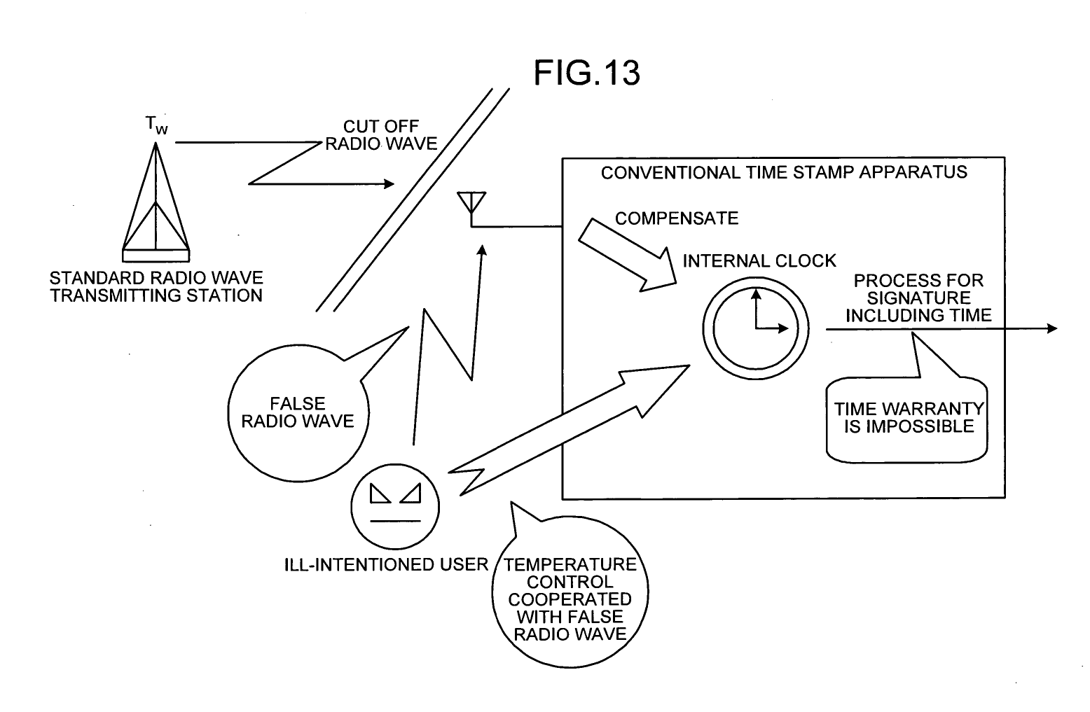

When the conventional time stamp apparatus once falls into the ill-intentioned user's hands, the alteration of time is allowed. The alteration of time will be described with reference to FIG. 13. FIG. 13 is a diagram illustrating the alteration of the internal time in the conventional time stamp apparatus.

As shown in FIG. 13, an ill-intentioned user carries the time stamp apparatus to a place such as a basement where standard radio waves do not penetrate, and transmits time deviated from the standard time using a radio wave (false radio wave) of the same type as the standard radio wave. Since the time stamp apparatus which receives the false radio wave compensates local time counted by the internal clock based on the false radio wave, the local time deviates from the true time.

In the time stamp apparatus which makes a compensation using the radio wave time, to prevent such a fraudulent act, when the difference between the local time and the radio wave time exceeds a predetermined value (ε), a prevention measure is frequently taken in such a manner that the compensation using the radio wave time is halted and the local time is directly used. However, when a temperature control which is cooperative with the false radio wave is made, this prevention measure is disabled.

In general, a crystal oscillator or TCXO (Temperature Compensated Xtal Oscillator) which is stabilized with respect to a temperature change by adding a temperature compensating circuit to the crystal oscillator is used for the apparatuses having the internal clock. Particularly, the TCXO is suitable for the time stamp apparatuses which are distributed and used in wide places. These oscillators have temperature characteristics such that when an error (upper direction is positive) is plotted along a vertical axis and a temperature change is plotted along a horizontal direction, a quadratic curve whose top generally rises is obtained.

Therefore, when the time stamp apparatuses including these oscillators are heated or cooled, the internal clock becomes slow. In the case of the TCXO, a control is made such that the error becomes about zero within a temperature range where the temperature compensating circuit operates, but when the temperature exceeds the temperature range, an error which causes abrupt time delay is generated.

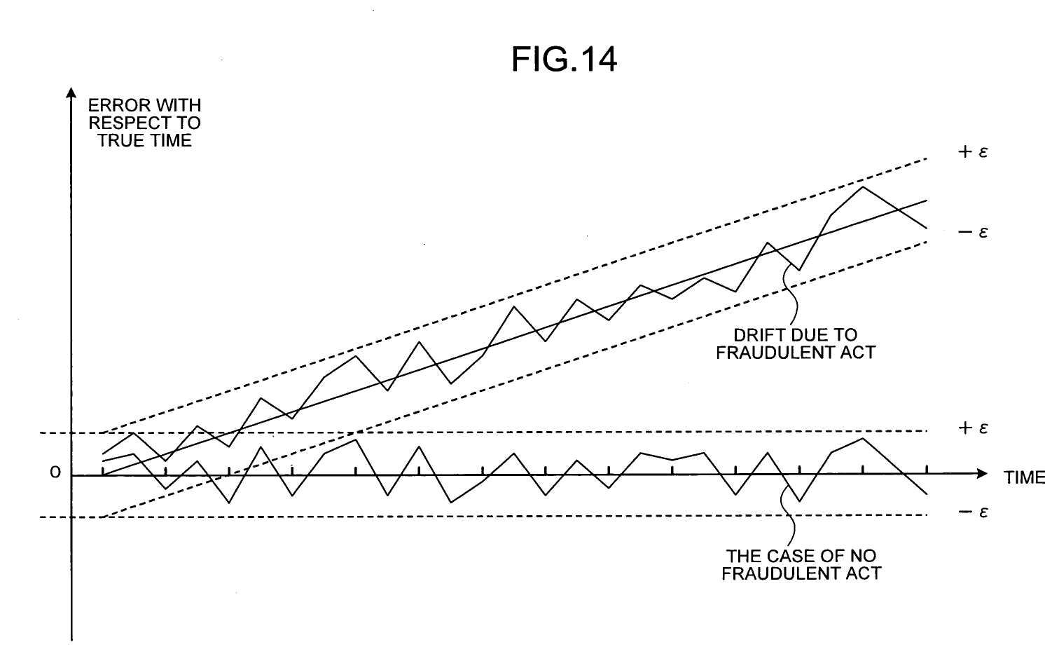

When such a temperature attack is cooperated with an attack by means of a false radio wave, the difference between the local time and the radio wave time (radio wave time based on the false radio wave) can be suppressed within the predetermined value (ε). For this reason, the local time is allowed to greatly deviate from the standard time (hereinafter, “drift by the fraudulent act”). The drift by the fraudulent act will be described with reference to FIG. 14. FIG. 14 is a diagram illustrating the drift by the fraudulent act in the conventional time stamp apparatus.

As shown in FIG. 14, when the fraudulent act is not carried out, the error between the local time and the standard time (true time) is suppressed within a range of −ε to +ε by the prevention measure where the predetermined value (ε) is a threshold. On the other hand, when the temperature attack is cooperated with the attack of false radio wave, the difference between the local time and the time included in the false radio wave is suppressed within the range of −ε to +ε but the local time greatly deviates from the true time.

In the conventional time stamp apparatus, the prevention measure against the alteration of time by ill-intentioned users is not sufficient, and the time authentication or the time warranty which is the object of the time stamp apparatus cannot be secured. Therefore, the time stamp apparatus having the time correcting process of the invention provides the structure for preventing such an alteration of time.

The summary of the time stamp apparatus according to this embodiment will be described below with reference to FIG. 1. FIG. 1 is a diagram illustrating the summary of the time stamp apparatus according to this embodiment. As shown in FIG. 1, the time stamp apparatus of the embodiment acquires radio wave time and also authentication time (T_{N}) from a time publishing server via a network, and uses the authentication time to correct local time counted by the internal clock.

The time publishing server is an apparatus that provides standard time managed by the server when an authentication key is presented and is connected to a network such as internet to provide standard time with high reliability via the network. This embodiment describes when the time stamp apparatus acquires the standard time (T_{N}) from the time publishing server. A time publishing apparatus that publishes standard time is connected to a server without the standard time publishing function, and may acquire the standard time (T_{N}) via the server, or may acquire the standard time (T_{N}) from the time publishing apparatus connected directly to the network.

In the time stamp apparatus of this embodiment, the radio wave time is used to trigger the acquisition of the authentication time (T_{N}) from the time publishing server. Specifically, a difference between the local time and the radio wave time is monitored, and the authentication time is acquired from the time publishing server based on the difference so that the local time is corrected.

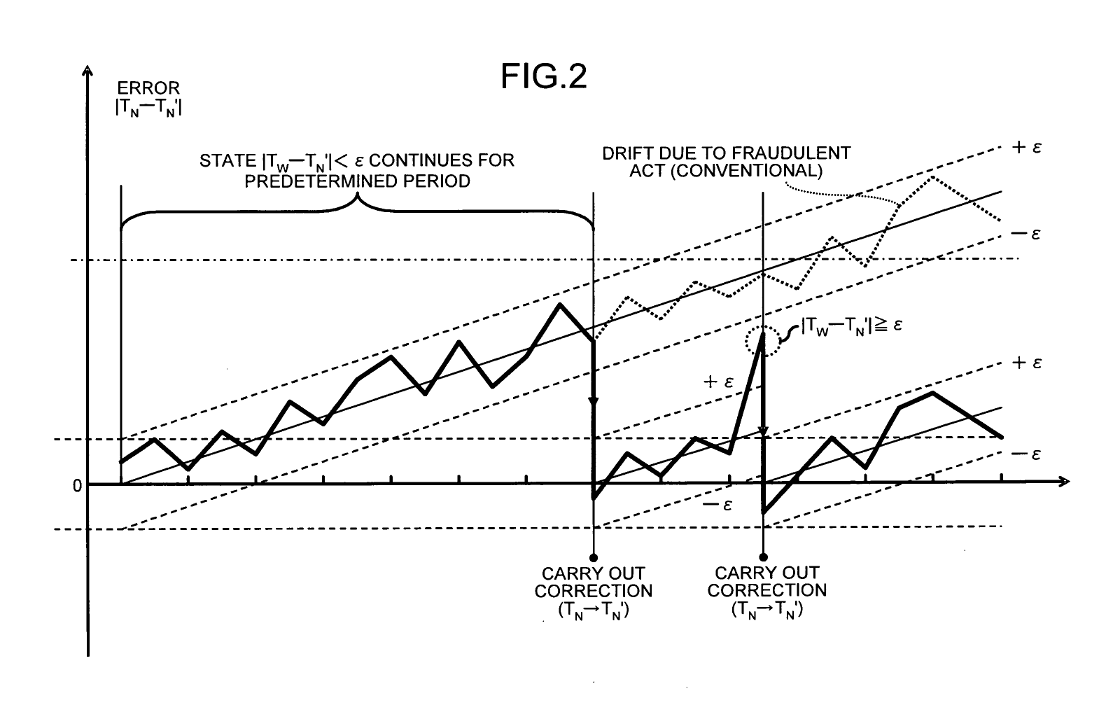

The time correction using the authentication time will be described in more detail below with reference to FIG. 2. FIG. 2 is a diagram illustrating the summary of the time correction. FIG. 2 corresponds to FIG. 14 relating to the conventional time stamp apparatus. T_{N}′ in the drawing designates the local time of the time stamp apparatus.

As shown in FIG. 2, in the time stamp apparatus of the embodiment, a threshold (σ) for time warranty is set, and a difference between the local time and true time is controlled so as to fall within a range of the threshold (σ). When a predetermined condition is satisfied, the authentication time (T_{N}) acquired from the time publishing server is corrected to be set as the local time (T_{N}′) so that the difference between local time and standard time is controlled to be suppressed within the range of the threshold (σ).

Specifically, the time stamp apparatus of this embodiment monitors the difference between the local time (T_{N}′) and the radio wave time (T_{W}). When the period during which the absolute value of the difference (|T_{W}−T_{N}′|) is less than the predetermined threshold (ε) continues for a predetermined time, the time stamp apparatus is connected to the time publishing server so as to acquire the authentication time (T_{N}). The time stamp apparatus then corrects to set the acquired authentication time (T_{N}) as the local time (T_{N}′). That is to say, in this case, a determination is made that the cooperative attack is possibly carried out. Seven days or the like is used as the predetermined period. When not the period but the number of different times is monitored, the number of times is seven times (in the case of one-time radio wave reception per day). When the period is used, a timer that refers to local time may be used, and when the number of times is used, a counter that counts the number of times may be used.

When the absolute value (|T_{W}−T_{N}′|) is equal to or more than the predetermined threshold (ε), the time stamp apparatus is connected to the time publishing server so as to acquire the authentication time (T_{N}) and corrects to set the acquired authentication time (T_{N}) as the local time (T_{N}′). That is to say, in this case, a determination is made that any one of the temperature attack and the attack of false radio wave is possibly carried out.

In the time stamp apparatus of this embodiment, the local time (T_{N}′) is not compensated to match with the radio wave time (T_{W}), but the difference between the radio wave time (T_{W}) and the local time (T_{N}′) is used as a trigger of the authentication time (T_{N}) acquisition, and the authentication time (T_{N}) is used to correct the local time (T_{N}′). Therefore, the local time (T_{N}′) cannot be altered even by the cooperative attack of temperature and false radio wave, and thus the reliability of the local time (T_{N}′) can be improved. Since a user may connect the time stamp apparatus to the time publishing server via the network as the need arises, the time stamp apparatus does not have to be always connected to the network.

Constitutional examples of the time stamp apparatus in this embodiment will be described with reference to FIGS. 3-1 to 3-3. In these constitutional examples, the portable time stamp apparatuses are assumed, but they may be of stationary type.

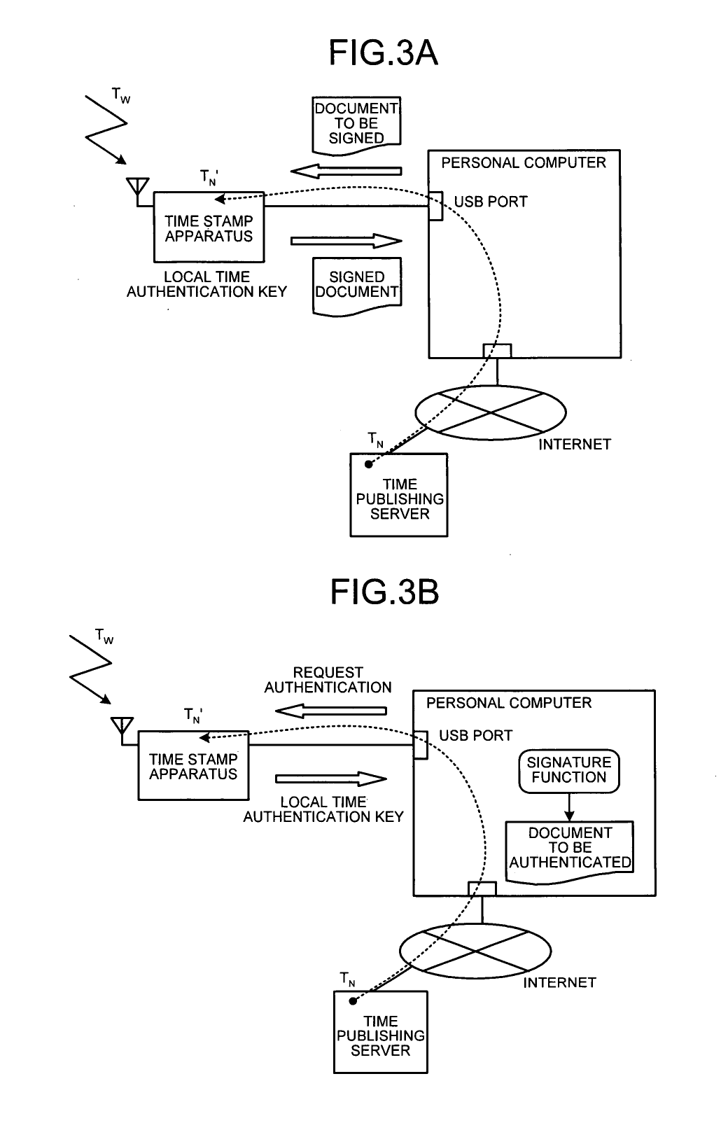

FIG. 3A is a diagram illustrating the constitutional example 1 of the time stamp apparatus. In the constitution shown in FIG. 3A, the time stamp apparatus is connected to a USB (Universal Serial Bus) port of a personal computer or the like connected to the internet so as to be used. The time stamp apparatus receives an electronic document to be e-signed from the personal computer, and adds the local time (T_{N}′) of the time stamp apparatus and the e-signature including the time to the electronic document using an authentication key, so as to send the e-signed electronic document to the personal computer.

When the time stamp apparatus carries out the time correction, it is connected to the time publishing server via the personal computer and the internet so as to acquire the authentication time (T_{N}). As to such a time stamp apparatus, forms of watches and mobile phones which are carried and used by users when necessary are assumed.

FIG. 3B is a diagram illustrating the constitutional example 2 of the time stamp apparatus. In the constitutional example shown in FIG. 3B, the apparatus is connected to the USB port of a personal computer connected to the internet so as to be used similarly to the example shown in FIG. 3A. A difference from the case of FIG. 3A is that a program installed into the personal computer has the e-signature function.

In this constitutional example, when e-signature is necessary, the personal computer transmits an authentication request message to the time stamp apparatus via the USB port. The time stamp apparatus which has received this message sends back local time and an authentication key to the personal computer. The personal computer adds the e-signature to a document to be authenticated according to its own signature function.

As in the case of FIG. 3A, when the time stamp apparatus corrects time, the apparatus is connected to the time publishing server via the personal computer and the internet so as to acquire the authentication time (T_{N}), and the use form is assumed in which the apparatus such as a watch or a mobile phone is easily carried and used by a user when necessary.

FIG. 3C is a diagram illustrating the constitutional example 3 of the time stamp apparatus. In the constitutional example shown in FIG. 3C, the time stamp apparatus is connected directly to a network such as internet. When the apparatus receives an electronic document to be e-signed, the apparatus adds e-signature to the electronic document using local time (T_{N}′) and the authentication key so as to output the e-signed electronic document. FIG. 3C illustrates when the time stamp apparatus receives the document to be e-signed from the outside, but the time stamp apparatus may retain the document to be e-signed in an internal memory or the like.

When the time stamp apparatus corrects time, the apparatus is connected to the time publishing server via the personal computer and the internet so as to acquire the authentication time (T_{N}). The use form in which the time stamp apparatus such as a watch or a mobile phone is easily carried and used by a user when necessary is assumed similarly to the case of FIGS. 3-1 and 3-2.

The constitutional examples of the time stamp apparatuses shown in FIGS. 3-1 to 3-3 depict when data to be e-signed is document data, but it is not limited to document data, and electronic data such as image data and video data can be data to be e-signed. Further, the time stamp apparatus is installed into the apparatus such as the digital camera, so that e-signature including time may be carried out every time of imaging.

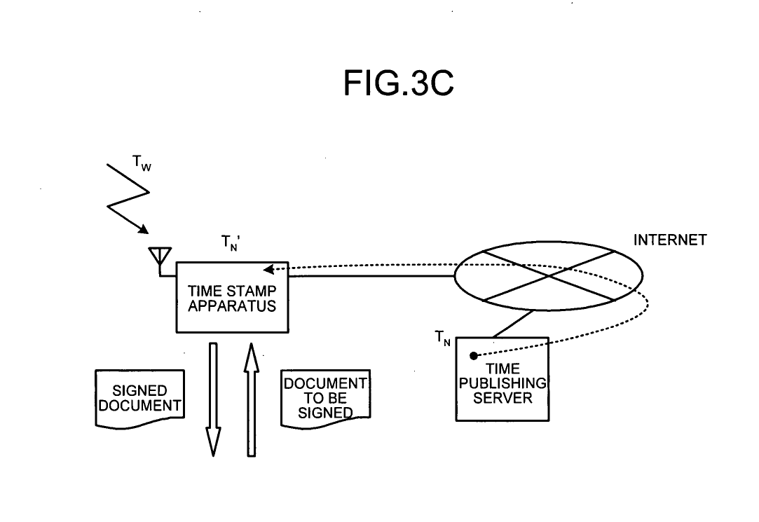

A constitution of the time stamp apparatus 1 including the time correcting process as the characteristic portion of this embodiment will be described below with reference to FIG. 4. FIG. 4 is a functional block diagram illustrating the constitution of the time stamp apparatus 1. The constitution shown in FIG. 4 illustrates the case where the time stamp apparatus 1 has the constitution shown in FIG. 3A.

As shown in the drawing, the time stamp apparatus 1 includes various devices such as a standard radio wave receiving unit 2, an oscillator 3, a communication interface unit 4, a displaying unit 5, an input unit 6, a controlling unit 10 and a storage unit 20.

The controlling unit 10 includes a radio wave time acquiring unit 11, a local time generating unit 13, an authentication time requesting unit 14, an authentication time acquiring unit 15, a time correcting unit 16, and a time stamp processing unit 17. The storage unit 20 includes an authentication key storage unit 21.

The standard radio wave receiving unit 2 receives a standard radio wave from a standard radio wave transmitting station or a satellite, and transmits radio wave time (T_{W}) synchronized with national standard time to the controlling unit 10. For example, the standard radio wave transmitted from the standard radio wave transmitting station includes time information such as hour, minute, second, total days from the first of the year, year (last two digits of dominical year), and a day of the week. The timing at which the standard radio wave receiving unit 2 receives the standard radio wave can be set to any value, and thus the timing can be specified such that the radio waves are received at 7:00 and 19:00, or the receiving process can be forcibly executed by a user's operation.

The oscillator 3 is a device such as a crystal oscillator that counts the local time, and provides an oscillated pulse to the controlling unit 10. Since the time stamp apparatus 1 is used in various temperature environments and the temperature attack is assumed, it is desirable that the oscillator 3 has stable time counting accuracy in a wide temperature range like TCXO (temperature compensated crystal oscillator).

The communication interface unit 4 is a device that enables bidirectional communication such as USB ports and LAN boards, and transmits/receives data between the time stamp apparatus 1 and the personal computer so as to exchange these data with the controlling unit 10. The data is transmitted and received to/from the time publishing server via the communication interface unit 4.

The displaying unit 5 is a display device such as a liquid crystal display, and is used to display warning information and error information from the controlling unit 10 and the respective devices and display local time. Further, the input unit 6 is a device such as a power button, and is used for various operations such as turning ON/OFF the time stamp apparatus 1, and posts the operated result to the controlling unit 10.

The controlling unit 10 generates local time, and suitably makes time compensation using the standard radio wave and time correction using authentication times so as to suppress the difference between the local time and the true time to a predetermined value or less and execute the e-signature process using this local time.

The radio wave time acquiring unit 11 is a processing unit that receives radio wave time (T_{W}) from the standard radio wave receiving unit 2, and transmits it to the authentication time requesting unit 14. The radio wave time (T_{W}) acquired by the radio wave time acquiring unit 11 is used as a determining element when the authentication time requesting unit 14 requests the time publishing server to publish authentication time.

The local time generating unit 13 is a processing unit that receives a pulse output from the oscillator 3, and generates local time (T_{N}′) based on this pulse. The local time (T_{N}′) is subject to the time correcting process using the authentication time (T_{N}) by means of the time correcting unit 16. The local time generating unit 13 posts the generated local time (T_{N}′) to the authentication time requesting unit 14 and the time stamp processing unit 17.

The authentication time requesting unit 14 is a processing unit that uses the local time (T_{N}′) generated by the local time generating unit 13 and an authentication key stored in the authentication key storage unit 21 so as to request the time publishing server on the network to publish authentication time at a predetermined timing. Further, when the publication of the authentication time is requested, a request message including the local time (T_{N}′) is encrypted by the authentication key so as to send it to the communication interface unit 4.

The authentication time requesting unit 14 forcibly requests the publication of the authentication time by means of a user's operation, and determines whether the connection to the time publishing server is necessary based on the radio wave time (T_{W}) acquired by the radio wave time acquiring unit 11. When the connection is necessary, the authentication time requesting unit 14 requests the time publishing server to publish authentication time.

Specifically, an absolute value (|T_{W}−T_{N}′|) of the difference between the radio wave time (T_{W}) and the local time (T_{N}′) is calculated, and the absolute value is compared with a predetermined threshold (ε). When the period during which the absolute value is less than the threshold (ε) (|T_{W}−T_{N}′|<ε) continues for a predetermined time, the time publishing server is requested to publish the authentication time. When the absolute value (|T_{W}−T_{N}′|) is equal to or more than the threshold (ε) (|T_{W}−T_{N}′|≧ε), the time publishing server is requested to publish the authentication time.

For example, there will be described when the period of “|T_{W}−T_{N}′|<ε” continues for seven days, the time publishing server is requested to publish the authentication time. When ε is 0.5 second and the radio wave time (T_{W}) is acquired once in a day, the local time (T_{N}′) can be corrected by the authentication time (T_{N}) within an error range of maximally 3.5 seconds (7×0.5) with respect to the true time.

When the authentication time requesting unit 14 is connected to the time publishing server based on the difference between the radio wave time (T_{W}) and the local time (T_{N}′) will be described here. However, the necessity of the connection to the time publishing server may be displayed on the displaying unit 5 to be posted to the user, so that the authentication time requesting unit 14 may be connected to the time publishing server by a user's operation. In this case, the time stamp process (e-signature with time process) is halted until the authentication time (T_{N}) is acquired from the time publishing server.

Specifically, when the user performs an operation of “forcible authentication time acquisition” (a corresponding button is pressed down) via the input unit 6 at arbitrary timing, the authentication time requesting unit 14 requests the time publishing server on the network to publish authentication time. In this case, information such as “the number of times or the period where |T_{W}−T_{N}′|<ε continues” or “the number of times or the period where |T_{W}−T_{N}′|≧ε continues” may be displayed on the displaying unit 5 so as to urge the user to perform the operation.

The authentication time requesting unit 14 may request the time publishing server to publish authentication time based on the local time (T_{N}′) generated by the local time generating unit 13 without being triggered by the user's operation. For example, when the difference between the standard time and the local time is desired to be suppressed within 45 seconds, if the difference in time per day is maximally 0.5 second, the time publishing server may be requested to publish authentication time with an interval of once in 90 days.

The authentication time acquiring unit 15 is a processing unit that receives the authentication time (T_{N}) transmitted from the time publishing server in response to the request from the authentication time requesting unit 14 via the communication interface unit 4, and transmits the received authentication time (T_{N}) to the time correcting unit 16. The authentication time acquiring unit 15 decodes the encrypted authentication time (T_{N}) using the authentication key stored in the authentication key storage unit 21.

The time correcting unit 16 is a processing unit that uses the authentication time (T_{N}) received from the authentication time acquiring unit 15 so as to correct the local time (T_{N}′) generated by the local time generating unit 13. The time adjustment based on the authentication time is called “correction” for the following reasons.

Since the radio wave time originally means standard time and hardly delays due to a radio wave, this is suitable as the time based on the local time. As described with reference to FIG. 2, however, since the radio wave time possibly suffers a fraudulent act due to a false radio wave, the radio wave time cannot be absolutely trusted.

On the other hand, since the authentication key is required for acquiring the authentication time, the authentication time has higher reliability than that of the radio wave time. To discriminate these time adjustments, therefore, the time adjustment based on the radio wave time is called “compensation”, and the time adjustment based on the authentication time with higher reliability is called “correction”.

The time stamp processing unit 17 is a processing unit that carries out e-signature including time on an electronic document using the local time generated by the local time generating unit 13 and corrected by the time correcting unit 16 and the authentication key stored in the authentication key storage unit 21. Specifically, the time stamp processing unit 17 receives the electronic document to be authenticated via the communication interface unit 4, and e-signs the received electronic document so as to output the e-signed electronic document via the communication interface unit 4.

The storage unit 20 is a storage device including a volatile RAM (Random Access Memory), and further has the authentication key storage unit 21 for storing an authentication key allocated in advance at the time of production therein. After the authentication key is stored, the storage unit 20 is always energized. Such a constitution is formed to prevent ill-intentioned users from fetching the authentication key. That is to say, if the ill-intentioned users try to disassemble the time stamp apparatus to fetch the authentication key, the electric power to the storage unit 20 is cut and the stored authentication key is lost.

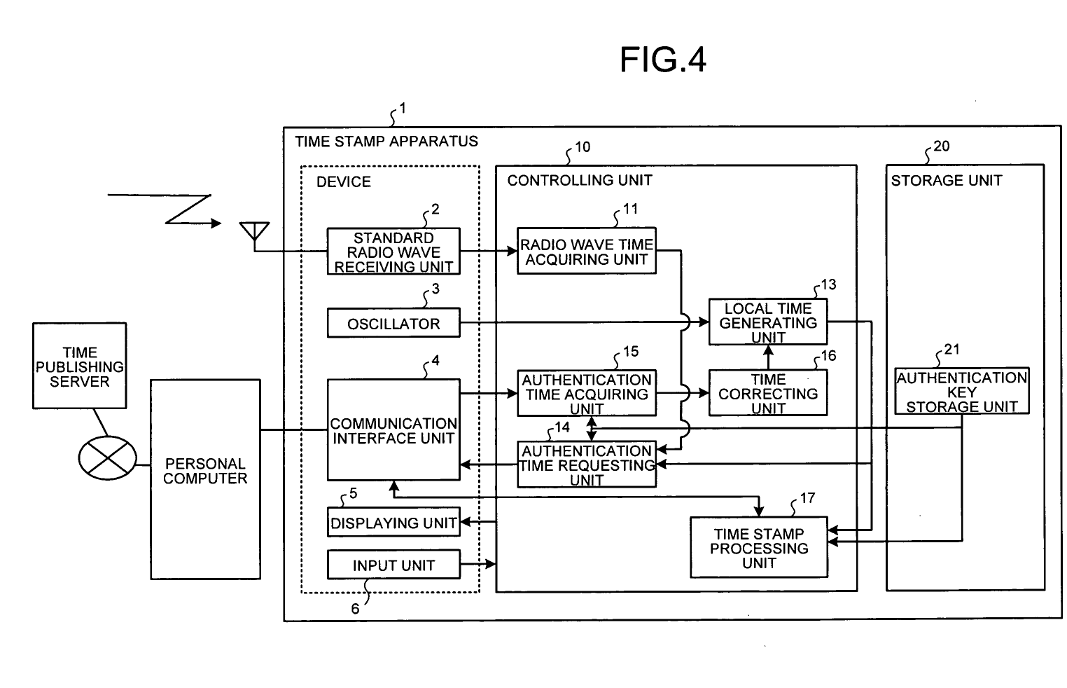

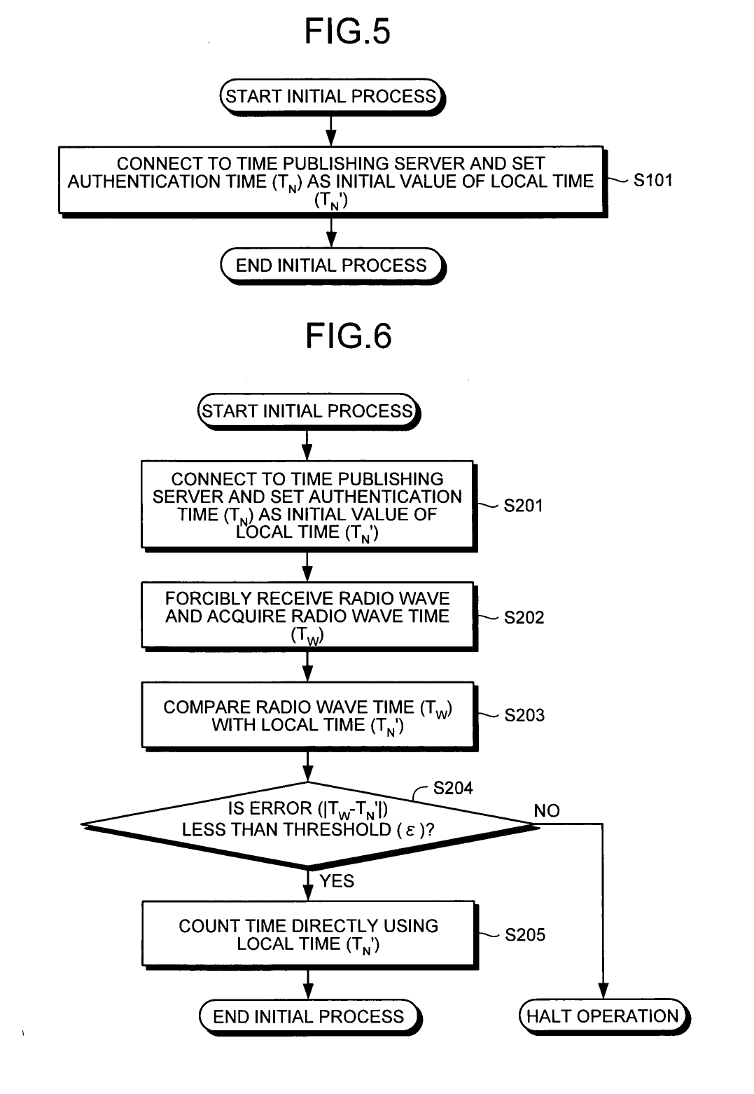

An initial process of the time stamp apparatus 1 will be described with reference to FIGS. 5 and 6. FIG. 5 is a flowchart illustrating a processing procedure of the initial process in which the radio wave time is not acquired, and FIG. 6 is a flowchart illustrating a processing procedure of the initial process where the radio wave time is acquired.

As shown in FIG. 5, when the radio wave time is not acquired, the authentication time requesting unit 14 is connected to the time publishing server to request it to acquire the authentication time (T_{N}). The time correcting unit 16 uses the authentication time (T_{N}) received from the time publishing server via the authentication time acquiring unit 15 as an initial value of the local time (T_{N}′) (step S101), and the initial process is ended.

On the other hand, when the radio wave time is acquired, as shown in FIG. 6, the authentication time requesting unit 14 is connected to the time publishing server to request it to acquire the authentication time (T_{N}). The time correcting unit 16 uses the authentication time (T_{N}) received from the time publishing server via the authentication time acquiring unit 15 as the initial value of the local time (T_{N}′) (step S201).

The radio wave time acquiring unit 11 then acquires the radio wave time (T_{W}) via the standard radio wave receiving unit 2 (step S202), and compares the radio wave time (T_{W}) with the local time (T_{N}′) (step S203), so as to determine whether the error (|T_{W}−T_{N}′|) is less than the predetermined threshold (ε) (step S204).

When the error is less than the predetermined threshold (ε) (Yes at step S204), the local time (T_{N}′) is directly used so that time is counted. On the other hand, when the error (|T_{W}−T_{N}′|) is equal to or more than the predetermined threshold (ε) (No at step S204), the operation of the time stamp apparatus 1 is stopped.

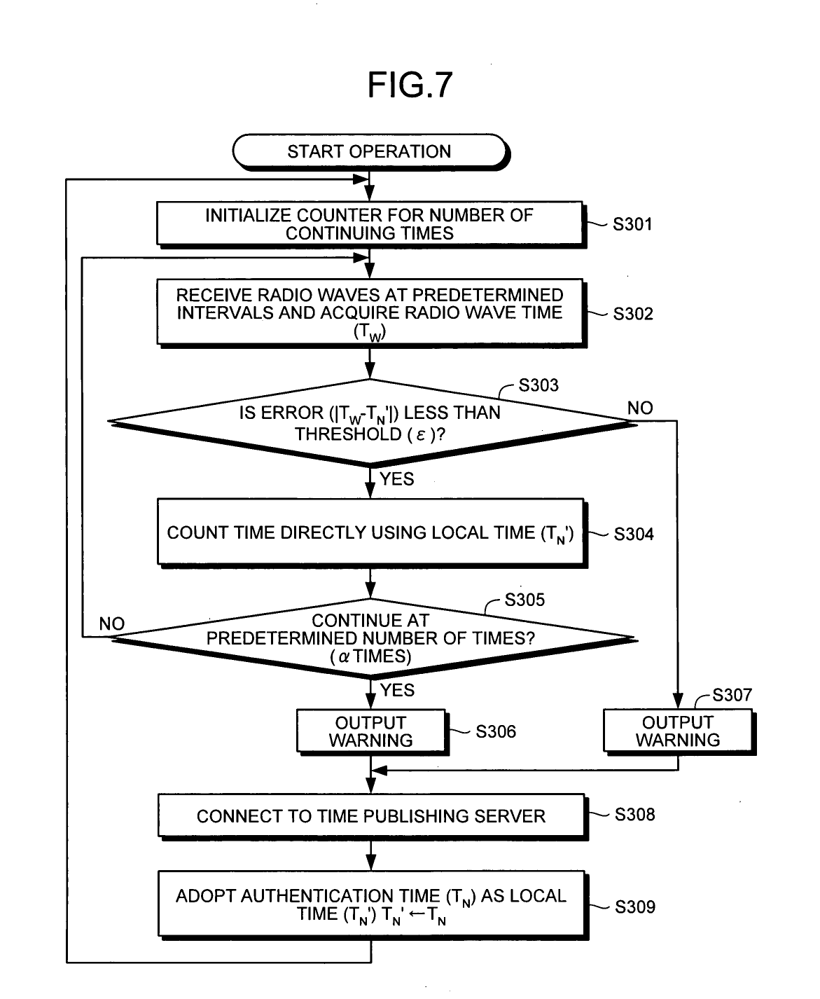

The processing procedure of the operation of the time stamp apparatus 1 will be described below with reference to FIG. 7. FIG. 7 is a flowchart illustrating the processing procedure of the time correcting process. As shown in the drawing, when the time stamp apparatus 1 starts to operate, the counter for counting the number of continuing times to be used in the later process is initialized (step S301). The radio wave time acquiring unit 11 acquires the radio wave time (T_{W}) via the standard radio wave receiving unit 2 at predetermined intervals (step S302).

The authentication time requesting unit 14 calculates the difference between the radio wave time (T_{W}) and the local time (T_{N}′), and determines whether the error |T_{W}−T_{N}′| is less than a compensating threshold (ε) (step S303). When the error |T_{W}−T_{N}′| is less than the compensating threshold (ε) (Yes at step S303), the local time (T_{N}′) is directly used so that the time counting continues (step S304). On the other hand, when the error |T_{W}−T_{N}′| is equal to or more than the compensating threshold (ε) (No at step S303), a warning is output to the displaying unit 5 (step S307) so that the user is urged to connect with the time publishing server.

A determination is made whether the number of times the error |T_{W}−T_{N}′| is less than the threshold (ε) is equal to or more than a predetermined value (α times) (step S305), and when it is equal to or more than α times (Yes at step S305), a warning is output to the displaying unit 5 (step S307) so that the user is urged to connect to the time publishing server. On the other hand, when the number is less than α times (No at step S305), the process on and after step S302 is repeated.

Then, to request the acquisition of the authentication time (T_{N}), the authentication time requesting unit 14 is connected to the time publishing server (step S308). When the time correcting unit 16 receives the authentication time (T_{N}) via the authentication time acquiring unit 15, it adopts the received authentication time (T_{N}) as the local time (T_{N}′) (step S309), so as to repeat the process on and after step S301.

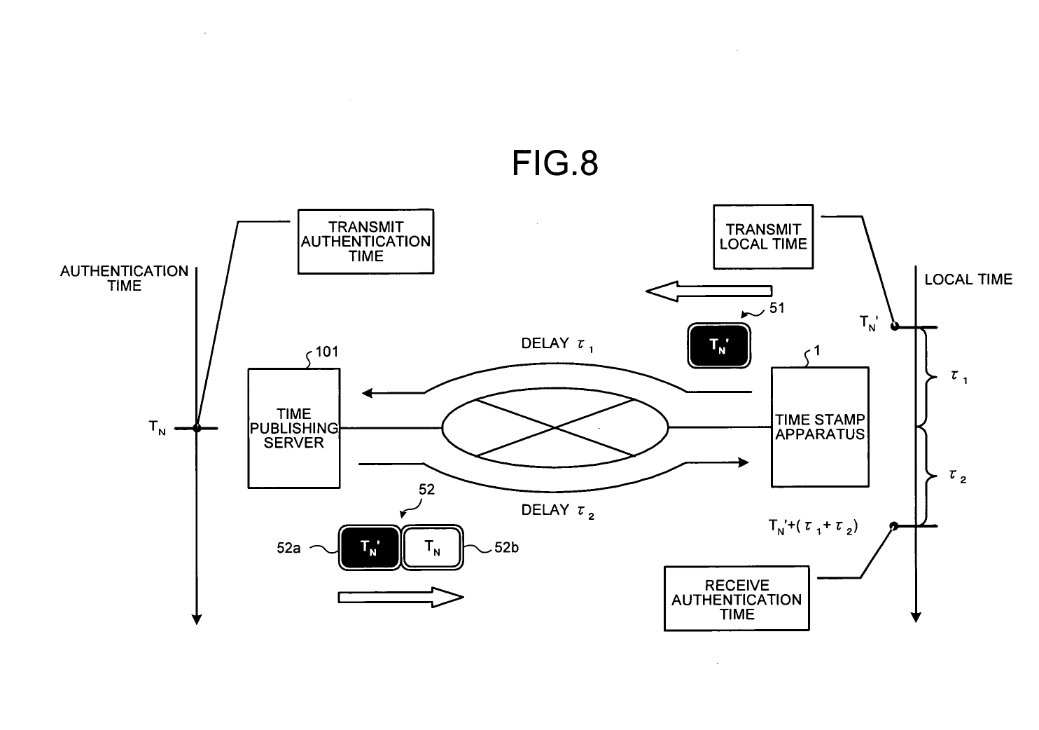

A delay compensating process at the time of acquiring the authentication time (T_{N}) from the time publishing server will be described below with reference to FIGS. 8 to 10. FIG. 8 is a diagram illustrating the summary of the delay compensating process for authentication time. As shown in the drawing, the period during which the time stamp apparatus 1 requests the time publishing server 101 to publish the authentication time (T_{N}) and receives the authentication time (T_{N}) includes out and home network delays.

Specifically, it takes time τ₁ for the request transmitted from the time stamp apparatus 1 to reach the time publishing server 101, and it takes time τ₂ for the authentication time (T_{N}) transmitted from the time publishing server 101 to reach the time stamp apparatus 1. That is to say, the time stamp apparatus 1 receives the authentication time (T_{N}) transmitted from the time publishing server 101 τ₂ time late. Normally, since the delay times (τ₁ and τ₂) are as short as about 100 msec, they do not become a problem, but when a fraudulent act such that the network is delayed is carried out, the strictness of the acquired authentication time (T_{N}) is not warranted.

Therefore, the time stamp apparatus 1 obtains the value τ₁+τ₂ so as to estimate the value τ₂ based on this obtained value. Specifically, the authentication time requesting unit 14 transmits a request message 51 which includes the local time (T_{N}′) at the time of requesting the authentication time. The time publishing server 101 which receives the request message 51 returns the authentication time (T_{N}) and a response message 52 which includes the received local time (T_{N}′). 52a in FIG. 8 designates the local time (T_{N}′) included in the response message, and 52b designates the authentication time (T_{N}).

The time stamp apparatus 1 subtracts 52a (T_{N}′) included in the response message from the time (T_{N}′+(τ₁+τ₂)) of the reception of the response message 52, so as to calculate (τ₁+τ₂) representing out and home delay time. The apparatus 1 divides (τ₁+τ₂) by 2 so as to estimate τ₂, and captures a value obtained by subtracting τ₂ from the received authentication time (T_{N}) as the authentication time.

In this embodiment, the delay time (τ₁+τ₂) obtained by one request is divided by 2 so that τ₂ is estimated. However, delay times (τ₁+τ₂) obtained by several times of request may be averaged, or delay times (τ₁+τ₂) obtained by requesting a plurality of time publishing servers 101 may be averaged.

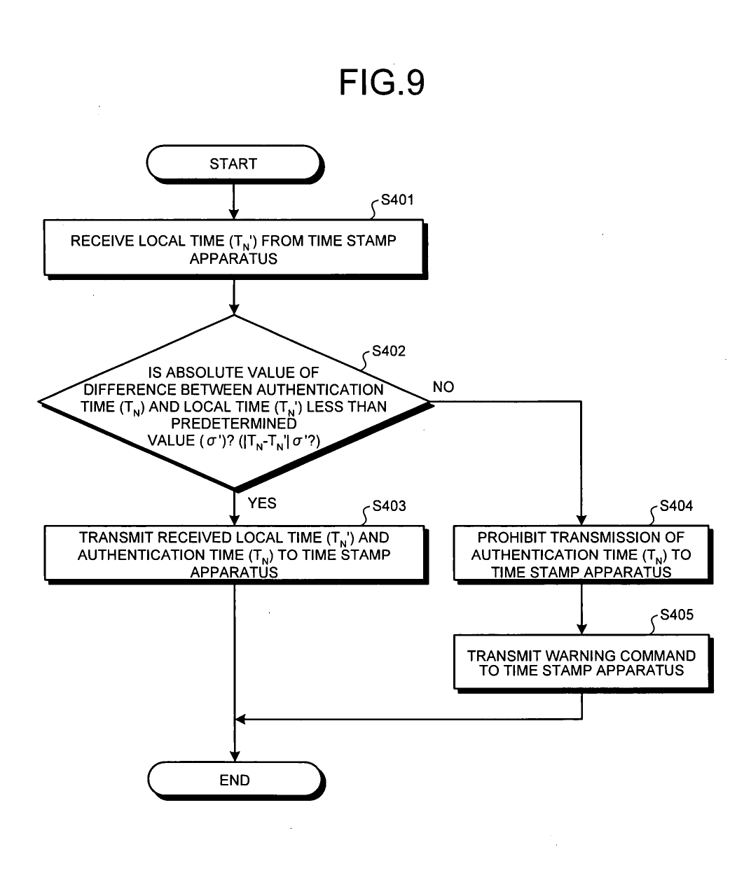

A processing procedure of the delay compensation in the time publishing server 101 will be described below with reference to FIG. 9. FIG. 9 is a flowchart illustrating the processing procedure of the delay compensation in the time publishing server. As shown in the drawing, when the time publishing server 101 receives the local time (T_{N}′) from the time stamp apparatus 1 (step S401), it determines whether an absolute value of the difference between the authentication time (T_{N}) managed by itself and the received local time (T_{N}′) is less than a predetermined value (σ′) (step S402).

When the absolute value of the difference between the authentication time (T_{N}) and the local time (T_{N}′) is less than the predetermined value (σ′) (Yes at step S402), the received local time (T_{N}′) and the authentication time (T_{N}) are transmitted to the time stamp apparatus 1 (step S403), so that the process is ended. On the other hand, when the absolute value is equal to or more than the predetermined value (σ′) (No at step S402), the transmission of the authentication time (T_{N}) to the time stamp apparatus 1 is prohibited (step S404), and a warning command is transmitted to the time stamp apparatus 1 (step S405) so that the process is ended.

In such a manner, the time publishing server 101 can halt the provision of the authentication time (T_{N}) to the time stamp apparatus 1 having the local time (T_{N}′) greatly deviating from the authentication time (T_{N}). Therefore, the time stamp apparatus 1 in which a fraudulent act is very likely carried out can be effectively prevented from being operated.

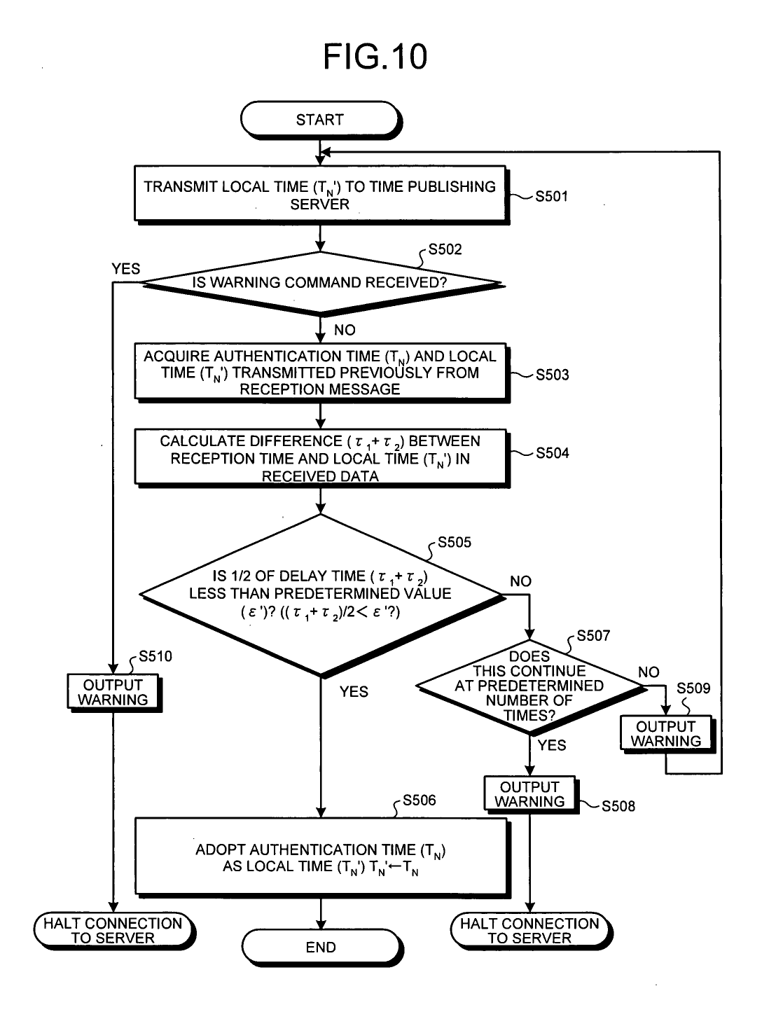

The processing procedure of the delay compensation in the time stamp apparatus 1 is described below with reference to FIG. 10. FIG. 10 is a flowchart illustrating the processing procedure of the delay compensation in the time stamp apparatus. As shown in the drawing, the time stamp apparatus 1 transmits the local time (T_{N}′) to the time publishing server 101 (step S501). When the time stamp apparatus 1 waits for the response from the time publishing server 101 and receives a warning command (Yes at step S502), it outputs a warning to the displaying unit 5 (step S510) so as to cut the connection to the time publishing server.

On the other hand, when the received message is not the warning command (No at step S502), the time stamp apparatus 1 acquires the authentication time (T_{N}) from the message and the local time (T_{N}′) transmitted before (step S503). The time stamp apparatus 1 calculates the difference (τ₁+τ₂) between the receiving time of the message and the local time (T_{N}′) included in the message. The difference (τ₁+τ₂) represents an out and home network delay.

Then, a determination is made whether a value obtained by dividing the delay time (τ₁+τ₂) by 2 is less than a predetermined value (ε′) (step S505). When (τ₁+τ₂)/2 is less than the predetermined value (ε′) (Yes at step S505), the received authentication time (T_{N}) is adopted as new local time (T_{N}′) (step S506), so that the process is ended.

On the other hand, when the value obtained by dividing the delay time (τ₁+τ₂) by 2 is equal to or more than the predetermined value (ε′) (No at step S505), a determination is made whether the number of times the value is equal to or more than the predetermined value (ε′) is the predetermined number of times (step S507). When this number of times is the predetermined number of times or more (Yes at step S507), a warning is output (step S508) so that the connection to the time publishing server is cut. Further, the number of continuing times is less than the predetermined number of times, a warning is output to the displaying unit 5 (step S509) so that the process on and after step S501 is repeated.

As mentioned above, in this embodiment, the local time generated by the local time generating unit is corrected by using the authentication time acquired by the authentication time acquiring unit from the time publishing server. The authentication time requesting unit requests the time publishing server to publish the authentication time by using, as triggers, the facts that the period during which the difference between the local time and the radio wave time is less than a predetermined value continues for a predetermined period and that the difference between the local time and the radio wave time is equal to or more than a predetermined value. The time correcting unit takes the delay time of the authentication time acquired via the authentication time acquiring unit into consideration so as to correct the local time. For this reason, the alteration of time by an ill-intentioned user is prevented so that the reliability of time to be used for e-signature is heightened, and even when the time stamp apparatus is not always connected to the network, the reliability of time can be warranted.

In this embodiment, when the number of consecutive times that an absolute value of the difference between the radio wave time and the local time is less than a first threshold is a predetermined number of times or when the period during which the absolute value is less than the first threshold continues for a predetermined period, the authentication time acquiring unit acquires the authentication time from the time publishing apparatus, and the time correcting unit sets the authentication time acquired by the authentication time acquiring unit as the local time. For this reason, the alteration of time by an ill-intentioned user is prevented so that the reliability of time to be used for e-signature is heightened, and even when the apparatus is not always connected to the network, the reliability of time can be warranted.

In this embodiment, when the absolute value of the difference is equal to or more than the first threshold, the authentication time acquiring unit acquires the authentication time from the time publishing apparatus, and the time correcting unit sets the authentication time acquired by the authentication time acquiring unit as the local time. For this reason, the alteration of time by an ill-intentioned user is prevented so that the reliability of time to be used for e-signature is heightened, and even when the apparatus is not always connected to the network, the reliability of time can be warranted.

In this embodiment, the authentication time acquiring unit acquires the authentication time from the time publishing apparatus periodically, and the time correcting unit sets the authentication time acquired by the authentication time acquiring unit as the local time. For this reason, the alteration of time by an ill-intentioned user is prevented so that the reliability of time to be used for e-signature is heightened, and even when the apparatus is not always connected to the network, the reliability of time can be warranted.

In this embodiment, when a predetermined operation is performed, the authentication time acquiring unit acquires the authentication time from the time publishing apparatus, and the time correcting unit sets the authentication time acquired by the authentication time acquiring unit as the local time. For this reason, the alteration of time by an ill-intentioned user is prevented so that the reliability of time to be used for e-signature is heightened, and even when the apparatus is not always connected to the network, the reliability of time can be warranted.

In this embodiment, when an absolute value of a difference between the authentication time acquired by the authentication time acquiring unit and the local time is less than a second threshold, the time correcting unit sets the authentication time as the local time. For this reason, a fraudulent act of delaying the network can be effectively detected.

In this embodiment, when the absolute value of the difference between the authentication time acquired by the authentication time acquiring unit and the local time is equal to or more than the second threshold, the time correcting unit does not correct the local time. For this reason, authentication time including an influence of a fraudulent act for delaying the network can be prevented from being captured.

In this embodiment, when the number of consecutive times that the absolute value of the difference between the authentication time acquired by the authentication time acquiring unit and the local time is equal to or more than the second threshold is a predetermined number of times or when the period during which the absolute value is equal to or more than the second threshold continues for a predetermined period, the time correcting unit halts addition of the local time to the e-signature and outputs a warning. For this reason, the influence of a fraudulent act for delaying the network is eliminated, so that the reliability of local time can be warranted.

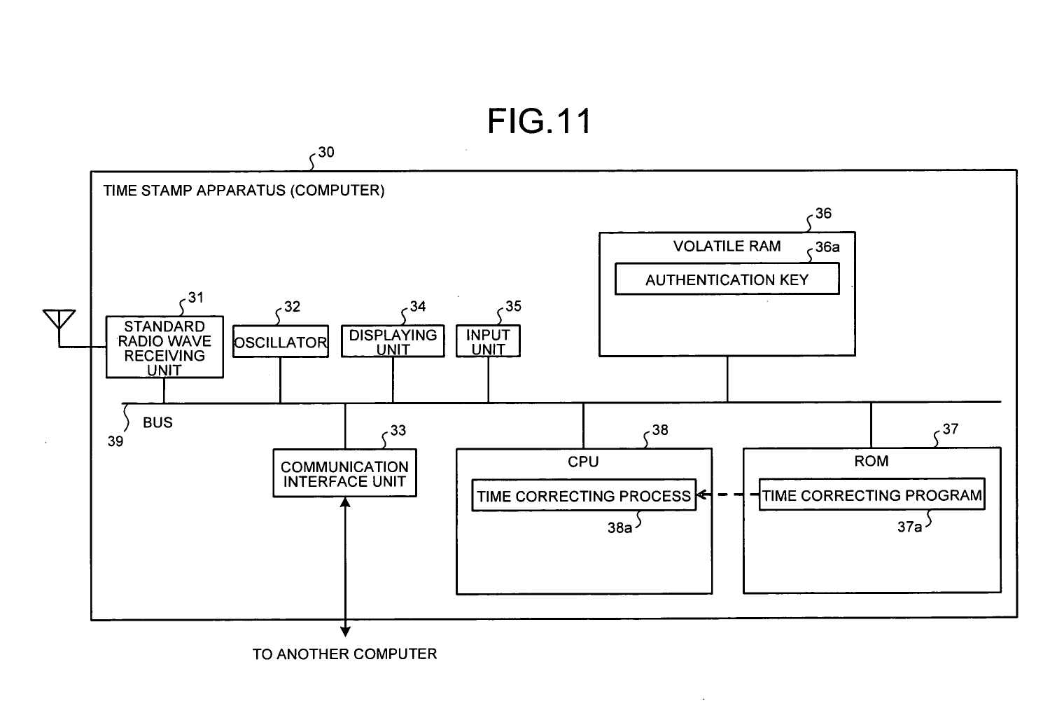

The respective processes described in the above embodiment can be realized by executing prepared programs using a computer. Therefore, one example of the computer executing the time correcting program having the same function as that of the embodiment will be described below with reference to FIG. 11. FIG. 11 is a diagram illustrating the computer which executes the time correcting program.

The “computer” includes not only personal computers but also a so-called “incorporated computer” built in apparatuses such as digital cameras and digital video cameras. When the time correcting program is operated by these computers, date and time of electronic data such as document data, image data and video data can be warranted.

As shown in the drawing, a computer 30 as the time stamp apparatus is constituted so that a standard radio wave receiving unit 31, an oscillator 32, a communication interface unit 33, a displaying unit 34, an input unit 35, a volatile RAM 36, a ROM (Read Only Memory) 37 and a CPU (Central Processing Unit) 38 are connected by a bus 39. The standard radio wave receiving unit 31, the oscillator 32, the communication interface unit 33, the displaying unit 34 and the input unit 35 correspond to the standard radio wave receiving unit 2, the oscillator 3, the communication interface unit 4, the displaying unit 5 and the input unit 6 shown in FIG. 4, respectively. The computer 30 is connected to another computer or a network via the communication interface unit 33.

A time correcting program 37a is stored in the ROM 37 in advance, and the CPU 38 reads and executes the time correcting program 37a in the ROM 37 so that the time correcting program 37a functions as a time correcting process 38a as shown in FIG. 11. An authentication key 36a is stored in the volatile RAM 36, and the authentication key 36a is used when the time correcting program 37a executes the time correcting process.

The time correcting program 37a is not necessarily stored in the ROM 37 in advance, and this program may be stored in “portable physical media” readable by the computer 30 such as a flexible disc (FD), a CD-ROM and magneto-optical disc or “another computer (or server)” connected to the computer 30 via a public line, an internet, a LAN and a WAN so as to be read and executed by the computer 30.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A time stamp apparatus that carries out e-signature including local time based on the local time output from an internal clock, comprising:
a radio wave time acquiring unit that receives a radio wave including standard time so as to acquire the standard time as radio wave time;
an authentication time acquiring unit that acquires authentication time from a time publishing apparatus for publishing the authentication time synchronous with the standard time; and
a time correcting unit that corrects the local time using the authentication time based on a difference between the radio wave time and the local time.

2. The time stamp apparatus according to claim 1, wherein
when the number of consecutive times that an absolute value of a difference between the radio wave time and the local time is less than a first threshold is a predetermined number of times or when a period during which the absolute value is less than the first threshold continues for a predetermined period, the authentication time acquiring unit acquires the authentication time from the time publishing apparatus, and
the time correcting unit sets the authentication time acquired by the authentication time acquiring unit as the local time.

3. The time stamp apparatus according to claim 2, wherein
when the absolute value of the difference is equal to or more than the first threshold, the authentication time acquiring unit acquires the authentication time from the time publishing apparatus, and
the time correcting unit sets the authentication time acquired by the authentication time acquiring unit as the local time.

4. The time stamp apparatus according to claim 1, wherein
the authentication time acquiring unit acquires the authentication time from the time publishing apparatus periodically, and
the time correcting unit sets the authentication time acquired by the authentication time acquiring unit as the local time.

5. The time stamp apparatus according to claim 1, wherein
when a predetermined operation is performed, the authentication time acquiring unit acquires the authentication time from the time publishing apparatus, and
the time correcting unit sets the authentication time acquired by the authentication time acquiring unit as the local time.

6. The time stamp apparatus according to claims 5, wherein
when an absolute value of a difference between the authentication time acquired by the authentication time acquiring unit and the local time is less than a second threshold, the time correcting unit sets the authentication time as the local time.

7. The time stamp apparatus according to claim 6, wherein when the absolute value of the difference between the authentication time acquired by the authentication time acquiring unit and the local time is equal to or more than the second threshold, the time correcting unit does not correct the local time.

8. The time stamp apparatus according to claim 7, wherein when the number of consecutive times that the absolute value of the difference between the authentication time acquired by the authentication time acquiring unit and the local time is equal to or more than the second threshold is a predetermined number of times or when a period during which the absolute value is equal to or more than the second threshold continues for a predetermined period, the time correcting unit halts addition of the local time to the e-signature and outputs a warning.

9. The time stamp apparatus according to claim 8, wherein the authentication time acquiring unit calculates delay time during which the time stamp apparatus requests the time publishing apparatus to publish the authentication time and acquires the authentication time, and when a value obtained by dividing the delay time by 2 is less than a third threshold, the authentication time acquiring unit acquires the authentication time.

10. The time stamp apparatus according to claim 9, wherein when the value obtained by dividing the delay time by 2 is equal to or more than the third threshold, the authentication time acquiring unit requests the time publishing apparatus to again publish the authentication time.

11. The time stamp apparatus according to claim 10, wherein the authentication time acquiring unit requests the time publishing apparatus to publish the authentication time a plurality of times and obtains representative delay time of the plurality of calculated delay times.

12. The time stamp apparatus according to claim 10, wherein the authentication time acquiring unit requests a plurality of time publishing apparatuses to publish the authentication time and obtains representative delay time of the plurality of calculated delay times.

13. The time stamp apparatus according to claim 11, wherein the authentication time acquiring unit transmits local time with signature to the time publishing apparatus so as to request the time publishing apparatus to publish the authentication time, and upon receiving the local time with signature and the authentication time from the time publishing apparatus, the authentication time acquiring unit subtracts the local time with signature from local time indicating reception time so as to calculate the delay time.

14. The time stamp apparatus according to claim 12, wherein the authentication time acquiring unit transmits local time with signature to the time publishing apparatus so as to request the time publishing apparatus to publish the authentication time, and upon receiving the local time with signature and the authentication time from the time publishing apparatus, the authentication time acquiring unit subtracts the local time with signature from local time indicating reception time so as to calculate the delay time.

15. A time publishing apparatus, wherein when an absolute value of a difference between standard time at the time of receiving local time with signature and the local time with signature is less than a fourth threshold, the time publishing apparatus returns authentication time at which the standard time is provided with signature and the local time with signature.

16. A time publishing apparatus, wherein when an absolute value of a difference between standard time at the time of receiving local time with signature and the local time with signature is equal to or more than a fourth threshold, the time publishing apparatus stops return of authentication time to a client and returns warning information with signature to the client.

17. A time correcting method for correcting a difference between local time output from an internal clock and standard time, comprising:
a radio wave time acquiring step of receiving a radio wave including standard time so as to acquire the standard time as radio wave time;
an authentication time acquiring step of acquiring authentication time from a time publishing apparatus for publishing the authentication time synchronous with the standard time when an authentication key is presented; and
a time correcting step of correcting the local time using the authentication time based on a difference between the radio wave time and the local time.

18. The time correcting method according to claim 17, wherein
at the authentication time acquiring step, when the number of consecutive times that an absolute value of a difference between the radio wave time and the local time is less than a first threshold is a predetermined number of times or when a period during which the absolute value is less than the first threshold continues for a predetermined period, the authentication time is acquired from the time publishing apparatus, and
at the time correcting step, the authentication time acquired at the authentication time acquiring step is set as the local time.

19. The time correcting method according to claim 17, wherein
at the authentication time acquiring step, when the absolute value of the difference is equal to or more than the first threshold, the authentication time is acquired from the time publishing apparatus,
at the time correcting step, the authentication time acquired at the authentication time acquiring step is set as the local time.

20. A computer program product for time correcting having a computer readable medium including programmed instructions, for correcting a difference between local time output from an internal clock and standard time, wherein the instructions, when executed by a computer, cause the computer to perform:
a radio wave time acquiring procedure of receiving a radio wave including standard time so as to acquire the standard time as radio wave time;
an authentication time acquiring procedure of acquiring authentication time from a time publishing apparatus for publishing the authentication time synchronous with the standard time when an authentication key is presented; and
a time correcting procedure of correcting the local time using the authentication time based on a difference between the radio wave time and the local time.

21. The computer program product for time correcting according to claim 20, wherein
at the authentication time acquiring procedure, when the number of consecutive times that an absolute value of the difference between the radio wave time and the local time is less than a first threshold is a predetermined number of times or when a period during which the absolute value is less than the first threshold continues for a predetermined period, and/or the number of consecutive times that the absolute value of the difference is equal to or more than the first threshold is a predetermined number of times or when a period during which the absolute value is equal to or more than the first threshold continues for a predetermined period, the authentication time is acquired from the time publishing apparatus, and
at the time correcting procedure, the authentication time acquired at the authentication time acquiring procedure is set as the local time.
